(19) United States
(12) Patent Application Publication
(10) Pub. No.: US 2015/0145494 A1
(43) Pub. Date: May 28, 2015

(54) DEVICE AND METHOD FOR TRACKING MAXIMUM POWER

(71) Applicant: Electronics and Telecommunications Research Institute, Daejeon (KR)

(72) Inventors: Sewan HEO, Daejeon (KR); Yil Suk YANG, Daejeon (KR)

(73) Assignee: Electronics and Telecommunications Research Institute, Daejeon (KR)

(21) Appl. No.: 14/268,589

(22) Filed: May 2, 2014

(30) Foreign Application Priority Data
Nov. 27, 2013 (KR) 10-2013-0145346

(51) Int. Cl. H02M 3/158

(52) U.S. Cl. CPC H02M 3/158
USPC 323/282

(57) ABSTRACT

Provided is a maximum power tracking device. The device includes: a battery outputting a first power; a switching unit changing the first power into a second power in response to a switching control signal; and a pulse modulation generation unit adjusting a pulse width of the switching control signal on the basis of the first power and adjusting a frequency of the switching control signal on the basis of the first power and the second power.

### CROSS-REFERENCE TO RELATED APPLICATIONS

This U.S. non-provisional patent application claims priority under 35 U.S.C. §119 of Korean Patent Application No. 10-2013-0145346, filed on Nov. 27, 2013, the entire contents of which are hereby incorporated by reference.

### BACKGROUND OF THE INVENTION

The present invention disclosed herein relates to a maximum power tacking device, and more particularly, to a maximum power tracking device and method maximizing the conversion efficiency of a DC-DC converter.

Recently, various developments on solar battery generating the most power among new regeneration energies are being made. Among them, various developments on solar battery collecting solar energy and converting it into electrical energy have been made.

In relation to a solar battery, the amount of energy varies depending on the intensity of solar light or the angle of light. Especially, the intensity of solar light, that is, an external environment factor, cannot be changed artificially. Also, the angle of solar light may be adjusted by changing the direction of a solar battery, but changing the direction requires high power consumption.

Additionally, an output power from a solar battery may be easily adjustable based on an output voltage. That is, by adjusting a level of an output voltage, the maximum power may be extracted from a solar battery.

However, while an electrical energy generated from a solar battery is converted into a voltage, power loss may occur. That is, due to the physical properties of devices in a voltage converter, for example, a capacitor and a transistor, power loss may occur.

### SUMMARY OF THE INVENTION

The present invention provides a maximum power tracking device and method maximizing the conversion efficiency of a DC-DC converter.

Embodiments of the present invention provide maximum power tracking devices including: a battery outputting a first power; a switching unit changing the first power into a second power in response to a switching control signal; and a pulse modulation generation unit adjusting a pulse width of the switching control signal on the basis of the first power and adjusting a frequency of the switching control signal on the basis of the first power and the second power.

In some embodiments, the devices may further include a conversion efficiency calculation unit calculating a conversion efficiency of the switching unit on the basis of the first and second powers, wherein the pulse modulation generation unit may adjust a frequency of the switching control signal on the basis of the conversion efficiency.

In other embodiments, the devices may further include a frequency adjustment unit generating a frequency control signal for adjusting the frequency of the switching signal in response to the conversion efficiency, wherein the pulse modulation generation unit may adjust the frequency of the switching control signal on the basis of the frequency control signal.

In still other embodiments, the devices may further include a clock generation unit generating a clock signal in response to the frequency control signal, wherein the pulse modulation generation unit may generate the switching control signal in response to the clock signal.

In even other embodiments, the devices may further include a voltage control unit generating a duty control signal in response to the first power, wherein the pulse modulation generation unit may adjust a duty ratio of the switching control signal in response to the duty control signal.

In yet other embodiments, the pulse modulation generation unit may adjust the pulse width and the frequency of the switching control signal to allow a value of the second power to be a maximum.

In further embodiments, the battery may receive solar energy and converts the received solar energy into electrical energy.

In still further embodiments, the switching unit may output the second power through DC-DC conversion.

In even further embodiments, the voltage control unit may be implemented using a maximum power point tracking (MPPT) method.

In other embodiments of the present invention, maximum power tracking methods of a maximum power tracking device include: outputting a first power from a battery; converting the first power into a second power in response to a switching control signal; adjusting a pulse width of the switching control signal on the basis of the first power; and adjusting a frequency of the switching control signal on the basis of the first power and the second power.

In some embodiments, the methods may further include calculating a conversion efficiency between the first and second powers, wherein a frequency of the switching control signal may be adjusted based on the conversion efficiency.

In other embodiments, the methods may further include generating the clock signal according to the adjusted frequency, wherein the switching control signal may be generated based on the clock signal.

### BRIEF DESCRIPTION OF THE DRAWINGS

The accompanying drawings are included to provide a further understanding of the present invention, and are incorporated in and constitute a part of this specification. The drawings illustrate exemplary embodiments of the present invention and, together with the description, serve to explain principles of the present invention. In the drawings:

FIG. 1 is a block diagram illustrating a maximum power tracking device according to an embodiment of the present invention.

FIG. 2 is a current-voltage graph depending on an output voltage change according to an embodiment of the present invention.

FIG. 3 is a circuit diagram illustrating one example of a switching unit of FIG. 1.

FIG. 4 is a graph illustrating the conversion efficiency of a switching unit according to frequency characteristics of the maximum power tracking device of FIG. 1.

FIG. 5 is a view illustrating PWM signals according to frequency characteristics of the maximum power tracking device of FIG. 1.

FIG. 6 is a flowchart illustrating an operation of a maximum power tracking device according to an embodiment of the present invention.

### DETAILED DESCRIPTION OF PREFERRED EMBODIMENTS

The present invention may apply various modifications and thus have diverse embodiments. Therefore, specific embodiments are shown in the drawings and described in more detail. Thus, it is intended that the present invention covers the modifications and variations of this invention provided they come within the scope of the appended claims and their equivalents.

Like reference numerals refer to like elements throughout. Also, in the figures, the dimensions of layers and regions are exaggerated for clarity of illustration. Although terms like first and second may be used to describe various components, the components are not limited to the terms. These terms are used only to distinguish one component from other components. For example, a first component may be referred to as a second component and vice versa without being departing from the scope of the present invention. The terms of a singular form may include plural forms unless they have a clearly different meaning in the context.

The meaning of “include,” “comprise,” “including,” or “comprising,” specifies a property, a region, a fixed number, a step, a process, an element and/or a component but does not exclude other properties, regions, fixed numbers, steps, processes, elements and/or components.

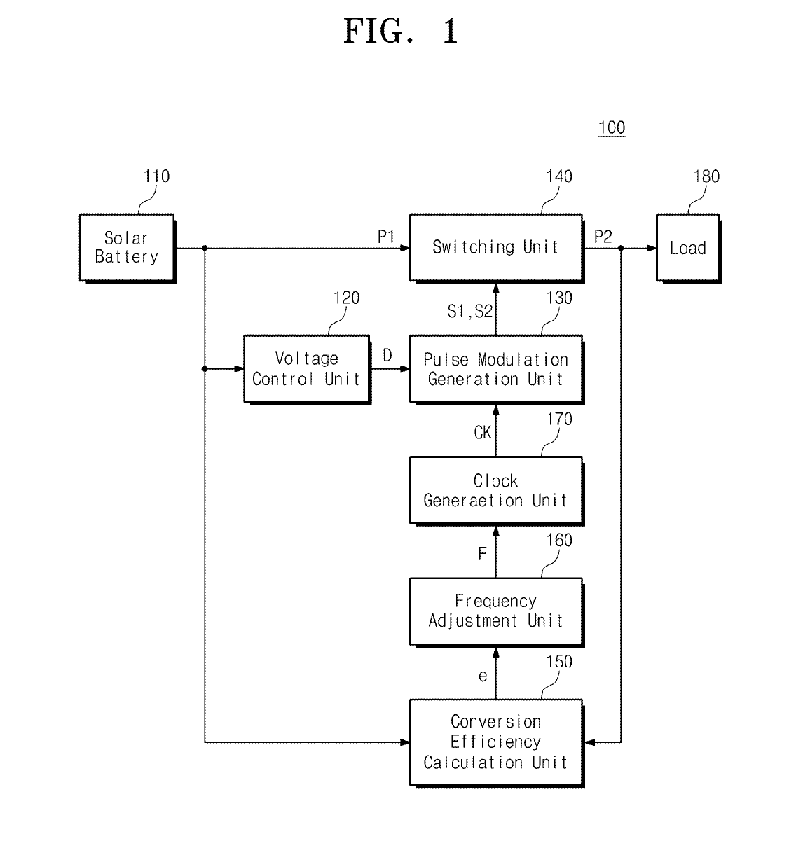

FIG. 1 is a block diagram illustrating a maximum power tracking device according to an embodiment of the present invention. Referring to FIG. 1, the maximum power tracking device 100 includes a solar battery 110, a voltage control unit 120, a pulse modulation generation unit 130, a switching unit 140, a conversion efficiency calculation unit 150, a frequency adjustment unit 160, a clock generation unit 170, and a load 180. The solar battery 110 receives solar energy from the sun and converts the received solar energy into electrical energy. That is, the solar battery 110 converts the received solar energy into power in an electrical energy form. The solar battery 110 delivers the converted power to each of the voltage control unit 120, the switching unit 140, and the conversion efficiency calculation unit 150.

In general, the magnitude of solar energy is a factor that cannot be artificially changed. However, although there is a method of adjusting the magnitude of solar energy by adjusting the angle of light, this requires high power consumption. Accordingly, as a method of adjusting an output power level of the solar battery 110, a method of adjusting an output power level on the basis of an output voltage of the solar battery 110 is mainly used.

The voltage control unit 120 receives an output voltage outputted from the solar battery 110. The voltage control unit 120 adjusts a level of an output current to allow a power level applied to the switching unit 130 to be the maximum in response to a level of the received output voltage. For this, the voltage control unit 120 generates a duty control signal D adjusting a level of an output current and delivers the generated duty control signal D to the pulse modulation generation unit 130.

Here, the output voltage refers to an output voltage outputted from the solar battery 110. That is, the voltage control unit 120 may be implemented using a maximum power point tracking (MPPT) method so as to track the maximum power point.

Additionally, although not shown in the drawing, the control unit 120 may use a perturb and observe (P&O) algorithm so as to track the maximum power from the solar battery 110. The P&O algorithm is a method of adjusting an output voltage continuously until the maximum power is obtained from the solar battery 110.

For example, if a power level outputted from the solar battery 110 is increased due to an increase of an output voltage, the voltage control unit 120 increases a level of the output voltage continuously. Then, at the time when a power level outputted from the solar battery 110 is decreased, the voltage control unit 120 decreases a level of the output voltage. The P&O algorithm is a method of outputting the maximum power from the solar battery 110 by repeating the above process.

The pulse modulation generation unit 130 generates first and second switching control signals S1 and S2 for controlling an operation of the switching an operation of the switching unit 140. That is, the pulse modulation generation unit 130 generates the first and second switching control signals S1 and S2 for controlling an operation of first and second transistors (see FIG. 3) according to a DC-DC conversion of the switching unit 140. For example, the pulse modulation generation unit 130 may be implemented using a pulse width modulation (PWM) method.

In more detail, the pulse modulation generation unit 130 receives a duty control signal D for adjusting a level of an output current on the basis of an output voltage from the voltage control unit 120. Additionally, the pulse modulation generation unit 130 receives a clock signal CK from the clock generation unit 170. The pulse modulation generation unit 130 may generate first and second switching signals in response to the received duty control signal D and clock signal CK.

The switching unit 140 receives a power outputted from the solar battery 110, that is, a first power P1, and converts the first power P1 into a second power P2 corresponding to the driving of the load 180. For example, the switching unit 140 may convert power through DC-DC conversion.

In more detail, the switching unit 140 receives first and second switching control signals S1 and S2 required for the level adjustment of the first power P1 from the pulse modulation generation unit 130. The switching unit 140 may change a level of the first power P1 into a level of the second power P2 in response to the received first and second switching control signals S1 and S2.

As mentioned above, the switching unit 140 may output the maximum power through the first and second switching control signals S1 and S2 for adjusting a level of an output voltage. However, power loss may occur while the first power P1 is converted into the second power P2. The maximum power tracking device 100 may minimize power loss occurring from the switching unit 140 through frequency control.

The conversion efficiency calculation unit 150 calculates the power loss occurring when the switching unit 140 converts the first power P1 into the second power P2. In more detail, the conversion efficiency calculation unit 150 receives the first power P1 from the solar battery 110 and receives the second power P2 outputted from the switching unit 140.

The conversion efficiency calculation unit 150 calculates a conversion efficiency e in response to the received first power P1 and second power P2.

$$e = \frac{P 2}{P 1} \qquad [ Equation 1 ]$$

The conversion efficiency e may be calculated through the above Equation 1. The conversion efficiency calculation unit 150 delivers the calculated conversion efficiency e to the frequency adjustment unit 160.

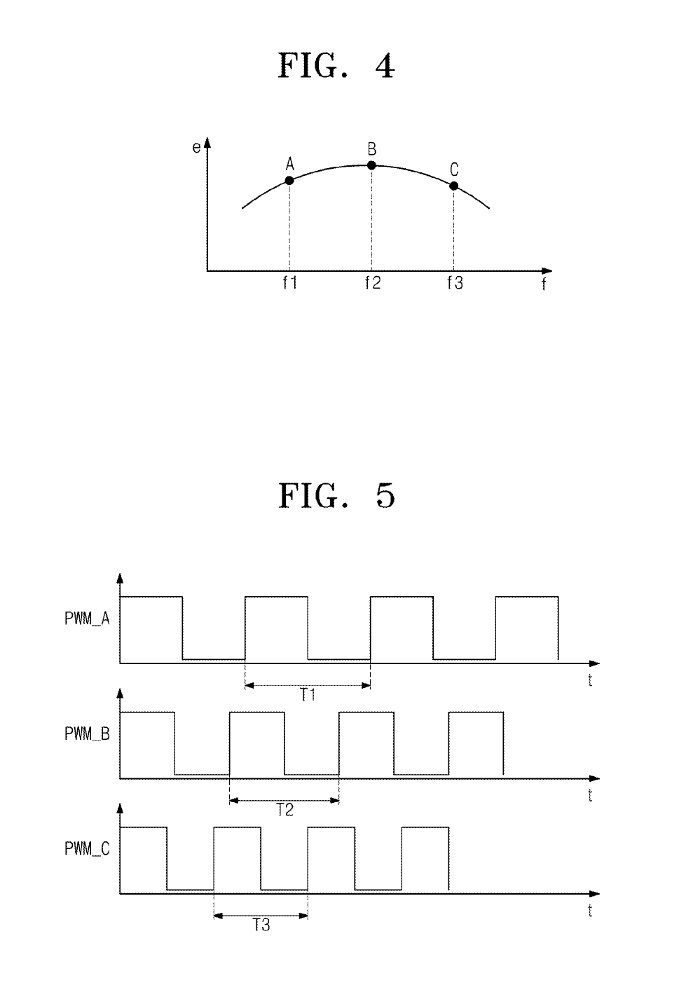

The frequency adjustment unit 160 receives the calculated conversion efficiency e from the conversion efficiency calculation unit 150. The frequency adjustment unit 160 generates a frequency control signal F for adjusting a frequency of a clock signal CK generated from the clock generation unit 170, in response to the conversion efficiency e. The conversion efficiency according to a frequency adjustment of a clock is described in more detail with reference to FIG. 4.

The clock generation unit 170 receives a frequency control signal F generated from the frequency adjustment unit 160. The clock generation unit 170 generates a clock signal CK in response to the received frequency control signal F. The clock generation unit 170 delivers the generated clock signal CK to the pulse modulation generation unit 130.

As mentioned above, the maximum power tracking device 100 may generate the maximum power by adjusting a level of an output voltage. Additionally, the maximum power tracking device 100 may minimize the power loss occurring during a power conversion process through a frequency adjustment of the clock signal CK.

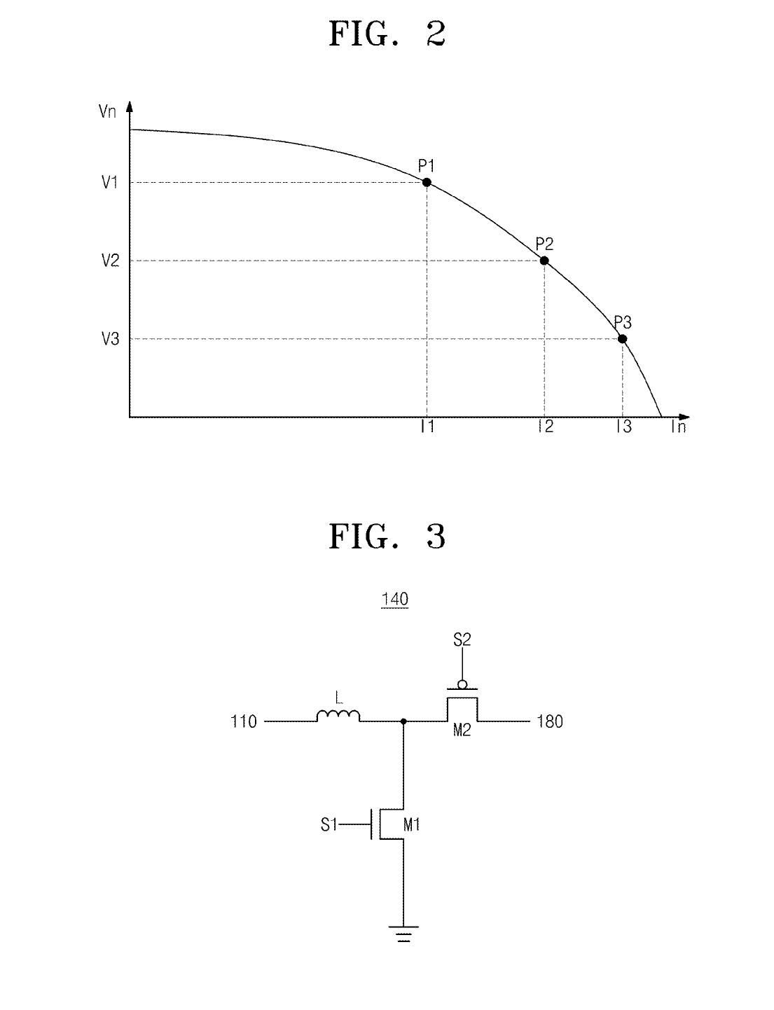

FIG. 2 is a current-voltage graph depending on an output voltage change according to an embodiment of the present invention. Referring to FIG. 2, it is observed that a level of a power outputted from a solar battery changes according to a level of an output voltage. Here, in the case of the second power P2, a power level outputted from the solar battery 110 may be the maximum.

Additionally, a power level outputted from the solar battery 110 may be changed in response to a level of an output voltage and an output current. That is, as a level of an output current is controlled to be decreased, a level of an output voltage may be increased. On the contrary, as a level of an output current is controlled to be increased, a level of an output voltage may be decreased.

For example, when a third power P3 is tracked from the solar battery 110, the voltage control unit 120 decreases a level of a third output current I3 on the basis of the third output voltage V3.

For example, when the first power P1 is tracked from the solar battery 110, the voltage control unit 120 increases a level of a first output current I1 on the basis of the first output voltage V1.

As mentioned above, the voltage control unit 120 performs the above process repeatedly until the second power P2, that is, the maximum power, is tracked. That is, the voltage control unit 120 generates a duty control signal D for adjusting a level of an output current In in response to a level of an output voltage outputted from the solar battery 110.

FIG. 3 is a circuit diagram illustrating one example of a switching unit of FIG. 1.

Referring to FIGS. 1 and 3, the switching unit 140 receives a first power P1 outputted from the solar battery 110. The switching unit 140 converts the received first power P1 into a second power P2 corresponding to the driving of the load 180 through DC-DC conversion. In more detail, the switching unit 140 includes an NMOS transistor M1, a PMOS transistor M2, and an inductor L.

The NMOS transistor M1 and the PMOS transistor M2 may be controlled by first and second switching control signals S1 and S2 outputted from the pulse modulation generation unit 130. In more detail, when the NMOS transistor M1 is turned on in response to the first switching control signal S1, the PMOS transistor M2 may be turned off in response to the second switching control signal S2. At this point, current is charged in the inductor L.

Moreover, when the NMOS transistor M1 is turned off in response to the first switching control signal S1, the PMOS transistor M2 may be turned on in response to the second switching control signal S2. At this point, the current charged in the inductor L is delivered to the load 180.

As mentioned above, the NMOS transistor M1 and the PMOS transistor M2 may operate complementary to each other. Additionally, the switching unit 140 is described as a configuration of a DC-DC boost but the present invention is not limited thereto, and thus, the switching unit 140 may be configured with a buck or a buck-boost.

However, power loss may occur while the first power P1 is DC-DC converted into the second power P2. For example, when a current is applied from drain terminals of the transistors M1 and M2 to source terminals, a conductive loss L1 may occur. At this point, the conductive loss L1 may be understood as a resistance component. Additionally, during a turn-on or turn-off operation of a transistor, a switching loss L2 may occur. At this point, the switching loss L2 may be understood as a capacitor component.

FIG. 4 is a graph illustrating the conversion efficiency of a switching unit according to frequency characteristics of the maximum power tracking device of FIG. 1.

Referring to FIGS. 3 and 4, the conversion efficiency e of the switching unit 140 may be adjusted according to a frequency setting.

For example, when a frequency is set to high through the frequency adjustment unit 160 of FIG. 1, the conductive loss L1 of the switching unit 140 may be decreased. However, in this case, the switching loss L2 may be increased. On the contrary, when a frequency is set to low through the frequency adjustment unit 160 of FIG. 1, the switching loss L2 of the switching unit 140 may be decreased. However, the conductive loss L1 may be increased.

Accordingly, the frequency adjustment unit 160 may set a frequency for minimizing the power loss of the switching unit 140 according to the conductive loss L1 and the switching loss L2. Here, when the first and second switching control signals S1 and S2 have a second frequency f2, the conversion efficiency e of the switching unit 140 may be the maximum.

Referring to the graph of FIG. 4, the conversion efficiency e is shown according to first to third frequencies f1, f2, and f3. The frequency f1 is lower than the second frequency f2 and the second frequency f2 is lower than the third frequency f3.

For example, when the first frequency f1 is set by the frequency adjustment unit 160, the switching loss L2 may be decreased but the conductive loss L1 may be increased. At this point, the frequency adjustment unit 160 generates a frequency control signal F for increasing a frequency on the basis of a result of the conversion efficiency e.

For example, when the third frequency f3 is set by the frequency adjustment unit 160, the switching loss L2 may be increased but the conductive loss L1 may be decreased. At this point, the frequency adjustment unit 160 generates a frequency control signal F for decreasing a frequency on the basis of a result of the conversion efficiency e.

As mentioned above, the frequency adjustment unit 160 performs the above process repeatedly until a point of the second frequency f2 at which the conversion efficiency e is the maximum, is tracked. That is, the frequency adjustment unit 160 generates a frequency control signal F for decreasing the power loss of the switching unit 140 in response to the conversion efficiency e.

FIG. 5 is a view illustrating PWM signals according to frequency characteristics of the maximum power tracking device of FIG. 1.

Referring to FIGS. 4 and 5, first to third pulse modulation signals PWM_A, PWM_B, and PWM_C have the same duty value. That is, a duty control signal D generated from the voltage control unit 120 may be a duty signal for generating the maximum power.

Additionally, as the first frequency f1 is lower than the second frequency F2, the first pulse modulation signal PWM_A may be a pulse signal having a longer period than the second pulse modulation signal PWM_B. As the second frequency f2 is lower than the third frequency F3, the second pulse modulation signal PWM_B may be a pulse signal having a longer period than the third pulse modulation signal PWM_C.

Referring to the graph of FIG. 5, for example, the pulse modulation generation unit 130 receives a duty control signal D for tracking the maximum power and a frequency control signal F set to have the first frequency f1 from the voltage control unit 120. The pulse modulation generation unit 130 may generate the first pulse modulation signal PWM_A having a period of a first time T1 in response to the duty control signal D and the frequency control signal F.

For example, the pulse modulation generation unit 130 receives a duty control signal D for tracking the maximum power and a frequency control signal F set to have the second frequency f2 from the voltage control unit 120. The pulse modulation generation unit 130 may generate the second pulse modulation signal PWM_B having a period of a second time T2 in response to the duty control signal D and the frequency control signal F.

For example, the pulse modulation generation unit 130 receives a duty control signal D for tracking the maximum power and a frequency control signal F set to have the third frequency f3 from the voltage control unit 120. The pulse modulation generation unit 130 may generate the third pulse modulation signal PWM_C having a period of a third time T3 in response to the duty control signal D and the frequency control signal F.

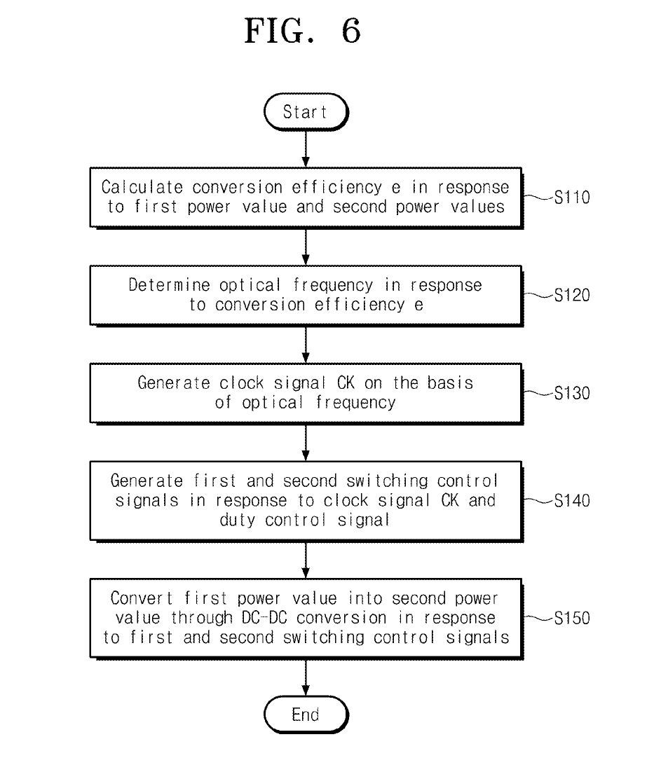

FIG. 6 is a flowchart illustrating an operation of a maximum power tracking device according to an embodiment of the present invention.

Referring to FIGS. 1 and 6, the conversion efficiency calculation unit 150 receives a first power value from the solar battery 110 and a second power value from the switching unit 140 in operation S110. The conversion efficiency calculation unit 150 calculates a conversion efficiency e in response to the received first and second power values.

In operation S120, the frequency adjustment unit 160 generates an optimal frequency for minimizing the power loss of the switching unit 140 in response to the conversion efficiency e.

In operation S130, the clock generation unit 170 generates a clock signal CK in response to the optimal frequency.

In operation S140, the pulse modulation generation unit 130 generates first and second switching control signals in response to the clock signal CK based on the optimal frequency and the duty control signal D generated from the voltage control unit 120.

In operation S150, the switching unit 140 converts a first power value outputted from the solar battery 110 into a second power value corresponding to the load 180 in response to the first and second switching control signals.

As mentioned above, the maximum power tracking device 100 may minimize the power loss occurring during a power conversion process through frequency adjustment. Additionally, the maximum power tracking device 100 may maintain the conversion efficiency of the switching unit 140 to be the maximum continuously by repeating a method of finding the optimal frequency.

According to an embodiment of the present invention, the driving performance of a maximum power tracking device may be improved.

The above-disclosed subject matter is to be considered illustrative, and not restrictive, and the appended claims are intended to cover all such modifications, enhancements, and other embodiments, which fall within the true spirit and scope of the present invention. Thus, to the maximum extent allowed by law, the scope of the present invention is to be determined by the broadest permissible interpretation of the following claims and their equivalents, and shall not be restricted or limited by the foregoing detailed description.

What is claimed is:

1. A maximum power tracking device comprising:
a battery outputting a first power;
a switching unit changing the first power into a second power in response to a switching control signal; and
a pulse modulation generation unit adjusting a pulse width of the switching control signal on the basis of the first power and adjusting a frequency of the switching control signal on the basis of the first power and the second power.

2. The device of claim 1, further comprising a conversion efficiency calculation unit calculating a conversion efficiency of the switching unit on the basis of the first and second powers,
wherein the pulse modulation generation unit adjusts a frequency of the switching control signal on the basis of the conversion efficiency.

3. The device of claim 2, further comprising a frequency adjustment unit generating a frequency control signal for adjusting the frequency of the switching signal in response to the conversion efficiency,
wherein the pulse modulation generation unit adjusts the frequency of the switching control signal on the basis of the frequency control signal.

4. The device of claim 3, further comprising a clock generation unit generating a clock signal in response to the frequency control signal,
wherein the pulse modulation generation unit generates the switching control signal in response to the clock signal.

5. The device of claim 4, further comprising a voltage control unit generating a duty control signal in response to the first power, wherein the pulse modulation generation unit adjusts a duty ratio of the switching control signal in response to the duty control signal.

6. The device of claim 1, wherein the pulse modulation generation unit adjusts the pulse width and the frequency of the switching control signal to allow a value of the second power to be a maximum.

7. The device of claim 1, wherein the battery receives solar energy and converts the received solar energy into electrical energy.

8. The device of claim 1, wherein the switching unit outputs the second power through DC-DC conversion.

9. The device of claim 1, wherein the voltage control unit is implemented using a maximum power point tracking (MPPT) method.

10. A maximum power tracking method of a maximum power tracking device, the method comprising:
outputting a first power from a battery;
converting the first power into a second power in response to a switching control signal;
adjusting a pulse width of the switching control signal on the basis of the first power; and
adjusting a frequency of the switching control signal on the basis of the first power and the second power.

11. The method of claim 10, further comprising calculating a conversion efficiency between the first and second powers, wherein a frequency of the switching control signal is adjusted based on the conversion efficiency.

12. The method of claim 11, further comprising generating the clock signal according to the adjusted frequency, wherein the switching control signal is generated based on the clock signal.
